(19) United States
(12) Patent Application Publication
(10) Pub. No.: US 2002/0141724 A1
(43) Pub. Date: Oct. 3, 2002

(54) Optical fiber element branching member and optical fiber element branching method

(76) Inventors: Takahiro Ogawa, Tokyo (JP); Hideki Miyazaki, Tokyo (JP); Masato Shiino, Tokyo (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/950,816

(22) Filed: Sep. 10, 2001

(30) Foreign Application Priority Data
Mar. 29, 2001 (JP) 2001-97199
Mar. 29, 2001 (JP) 2001-97217

(51) Int. Cl. G02B 6/00; G02B 6/36

(52) U.S. Cl. 385/137; 385/136; 385/76

(57) ABSTRACT

An optical fiber element branching member for an optical fiber cord in which a plurality of optical fiber elements are coated with outer coating and a fiber cord branching method using the same member. The optical fiber element branching member comprises an optical fiber element arranging portion, a cord fixing portion and a base. The optical fiber element arranging portion includes a plurality of holes or concave grooves allowing optical fiber elements to pass through. Further, the optical fiber element arranging portion is/are attachable/detachable to/from the base. In another embodiment, the optical fiber element branching member includes a tension member disposed around the plurality of optical fiber elements with outer coating. The optical fiber element branching member comprises an optical fiber element arranging portion capable of arranging two or more optical fiber elements exposed by removing the outer coating from the optical fiber cord and peeling the tension member.

### BACKGROUND OF THE INVENTION

1. Field of the Invention

The present invention relates to an optical fiber element branching member for use in branching and taking out optical fiber elements from an optical fiber cord having plural optical fiber elements having a plurality of optical fiber elements. Further, the present invention relates to an optical fiber element branching method for branching and taking out the optical fiber elements from the optical fiber cord having plural optical fiber elements.

2. Background of the Art

Conventionally, as an optical fiber element branching member for branching and taking out the optical fiber elements from an optical fiber cord, there is one in FIG. 5A. The fiber cord b shown in FIG. 5A has a plurality of fiber ribbons having plural optical fiber elements. The said optical fiber element branching member shown in FIG. 5A comprises a base ‘a’, a cord fixing portion c for fixing the optical fiber cord having plural optical fiber elements b onto the base ‘a’, and an optical fiber element arranging portion e for arranging respective optical fiber elements d branched from the optical fiber cord having plural optical fiber elements b fixed on the cord fixing portion c. In the optical fiber element arranging portion e, as shown in FIG. 5B, plural protective tubes g are disposed in a cylindrical body f. Respective optical fiber elements d (FIG. 5A) branched from the optical fiber cord having plural optical fiber elements b fixed on the cord fixing portion are passed through arbitrary protective tubes g, so that the optical fiber elements d are arranged in order.

Conventionally, as the optical fiber element branching member for branching and taking out the optical fiber elements from the optical fiber cord having plural optical fiber elements, there is another one shown in FIG. 13, in which the tension member D is disposed around plural optical fiber elements F and outside thereof is coated with the outer coating C. In this optical fiber element branching member shown in FIG. 13, an optical fiber element E branched by removing outer coating C from the optical fiber cord having plural optical fiber elements A inserted and fixed in a case B and peeling a tension member D is arranged in order by an optical fiber element arranging portion F. As shown in FIG. 14A, the peeled tension member D is folded back to the side of the outer coating C and applied to outside of a cylindrical metallic part G mounted on the fiber cord A. Further, as shown in FIG. 14B, by mounting the other metallic part H on outside of the tension member D, the tension member D is sandwiched between the metallic parts G and H. Further, in the optical fiber element arranging portion F, as shown in FIG. 15, plural protective tubes K are disposed in a cylindrical tube holding portion J and the gap around the tubes K is filled with adhesive agent L so that it is hardened. If the aforementioned exposed optical fiber elements E are passed through arbitrary protective tubes K, those optical fiber elements E are arranged in order.

Conventionally, as shown in FIG. 16, there is also an optical fiber element branching member in which heat shrinkable tubing M is applied to the outside of the tension member D without folding back the tension member D to the side of the outer coating C of the optical fiber cord having plural optical fiber elements A, so that the tension member D is bundled together with the optical fiber elements E. In FIG. 16, representation of the case is omitted.

Since in an optical fiber element arranging portion e shown in FIG. 5A, a predetermined number of the protective tubes are disposed within an internal space of the body f and its gap is filled with adhesive agent h as shown in FIG. 5B. Therefore, the arrangement of the protective tubes varies depending on a product. Thus, the conventional optical fiber element branching member having such optical fiber element arranging portion e has the following problems.

(1) The optical fiber element d cannot be easily passed through the protective tube g in the optical fiber element arranging portion e, so that work efficiency thereof is worse.

(2) Because the arranging condition of the optical fiber elements d depends on the arrangement of the protective tube g, which varies depending on a product, the optical fiber elements d cannot be always arranged in the same condition. Thus, it takes much labor and time to discern the numbers of the inserted optical fiber elements d.

(3) Because which optical fiber element d should be passed through which protective tube g is not determined, unless the optical fiber element d is actually passed through the protective tube g, the number of the optical fiber element d passed through the protective tube g cannot be discriminated.

(4) In the case where any external force is applied to the branching member, the optical fiber cord having plural optical fiber elements b connected thereto or the like, a bending force applied to the respective optical fiber elements d differs largely. For this reason, overlapping, twisting, hooking and the like may occur between the optical fiber elements, thereby sometimes causing increase of loss or disconnection.

Because in the optical fiber element branching member shown in FIG. 13, the optical fiber element arranging portion F is produced as described previously, the arranging condition of the protective tube K in the tube holding portion J differs depending on a product, so that the following problems arise.

(1) The optical fiber elements E cannot be passed through the protective tubes K easily thereby work efficiency being worse.

(2) Because the arranging condition of the optical fiber elements E depends on the arrangement of the protective tube K, which varies depending on a product, the optical fiber elements E cannot be always arranged in the same condition. Therefore, it takes much labor and time to discern the numbers of the inserted optical fiber elements E.

(3) Because which optical fiber element E should be passed through which protective tube K is not determined, unless actually, the optical fiber element E is passed through the protective tube K, the number of the optical fiber element E passed through the protective tube K cannot be discriminated.

(4) In the case where any external force is applied to the branching member, the optical fiber cord having plural optical fiber elements A connected thereto or the like, a bending force applied to the respective optical fiber elements E differs largely. For this reason, overlapping, twisting, hooking and the like may occur between the optical fiber elements, thereby sometimes causing increase of loss or disconnection.

In addition to the above described problems, the optical fiber element branching member in which the tension member D is sandwiched and held between two metallic parts G and H as shown in FIGS. 14A, 14B has the following problems.

(1) Generally, because the tension member D applied to the outer periphery of one metallic part G is bonded to the outer periphery of the same part G, a sufficient fixing strength can be secured even if the other metallic part H for sandwiching the tension member D is not employed. However, in this case, two metallic parts G and H are necessary, so that waste cost is consumed.

In addition to the above-described problems, the optical fiber element branching member in which the tension member D is bundled together with the optical fiber elements E using heat shrinkable tubing M as shown in FIG. 16 has the following problems.

(1) There is such a fear that the tension member D may contact the optical fiber element E thereby making a bad influence such as deterioration of transmission loss.

(2) There is such a fear that when the heat shrinkable tubing M is shrunk, bending, twisting or the like may occur to optical fiber element E which is within the heat shrinkable tubing. If it is expected that bending or twisting occurs, it is necessary to remove the heat shrinkable tubing temporarily shrunk and confirm the condition of the optical fiber element E, thereby leading to drop of yield rate. Further, because the tension member D still exists around the optical fiber element E even if the heat shrinkable tubing M is removed, it is difficult to recognize the condition of the optical fiber element E, thereby leading to drop of yield rate.

### SUMMARY OF THE INVENTION

An object of the present invention is to provide an optical fiber element branching member for branching the optical fiber elements from the optical fiber cord having plural optical fiber elements, in which plural optical fiber elements are bundled, and taking out the optical fiber elements. To achieve the above-described object, there is provided an optical fiber element branching member comprising: a cord fixing portion through which an optical fiber cord having plural optical fiber elements is to be passed through; an optical fiber element arranging portion for arranging optical fiber elements branched from the optical fiber cord having plural optical fiber elements passed through the cord fixing portion individually; and a base in which the cord fixing portion and the optical fiber element arranging portion are set up. The optical fiber element arranging portion includes two or more through holes allowing the optical fiber elements to pass through or two or more concave grooves capable of accommodating the optical fiber elements. If the optical fiber elements are inserted through predetermined through holes or accommodated in the concave grooves individually, the optical fiber elements are arranged in a desired condition.

Further, another object of the present invention is to provide an optical fiber element branching and taking out method for branching the optical fiber elements from the optical fiber cord having plural optical fibers using the aforementioned optical fiber element branching member. To achieve the above object, there is provided a fiber element branching method comprising: inserting and fixing the optical fiber cord having plural optical fiber elements in a cord fixing portion of the optical fiber element branching member; and passing the respective optical fiber elements branched from the optical fiber cord having plural optical fiber elements through the through holes in the optical fiber element arranging portion or accommodating the respective optical fiber elements in the concave grooves or passing the respective optical fiber elements through the protective tubes disposed in the through holes or concave grooves. Consequently, after the optical fiber elements are arranged in a desired condition, the cord fixing portion and the optical fiber element arranging portion are mounted on a base.

Still another object of the present invention is to provide an optical fiber element branching member for branching and taking out the optical fiber elements from the optical fiber cord having plural optical fiber elements in which a tension member is disposed around the plural optical fiber elements and outside thereof is coated with outer coating. To achieve the above object, there is provided an optical fiber element branching member wherein an optical fiber element arranging portion and a holding portion are provided in a case allowing the optical fiber cord having plural optical fiber elements in which the tension member is disposed around plural optical fiber elements and outside thereof is coated with an outer coating to pass through, the optical fiber element arranging portion being capable of arranging optical fiber elements branched from the optical fiber cord having plural optical fiber elements passed through the case while removing the outer coating from the optical fiber cord having plural optical fiber elements and peeling the tension member located on an inner side thereof, the holding being capable of holding the tension member peeled from the optical fiber element.

### BRIEF DESCRIPTION OF THE DRAWINGS

FIG. 1 is a disassembly explanatory diagram showing an example of an embodiment of an optical fiber element branching member of the present invention;

FIG. 2 is an enlarged explanatory diagram of an optical fiber element arranging portion shown in FIG. 1;

FIG. 3 is an explanatory diagram showing an end portion of the optical fiber element arranging portion shown in FIG. 1;

FIG. 4 is an enlarged explanatory diagram showing other example of the optical fiber element arranging portion;

FIG. 5A is an explanatory diagram showing an example of a conventional optical fiber element branching member while

FIG. 5B is an enlarged explanatory diagram of the optical fiber element arranging portion shown in FIG. 5A;

FIG. 6 is a plan view showing an example of the embodiment of the optical fiber element branching member of the present invention;

FIG. 7 is a perspective view showing a case for the optical fiber element branching member shown in FIG. 6;

FIG. 8A is an explanatory diagram showing a preprocessing step for inserting and fixing optical fiber cord having plural optical fiber elements in the case, while

FIG. 8B is an explanatory diagram showing a pre-processing step for inserting and fixing the optical fiber cord having plural optical fiber elements in the case;

FIG. 9 is a plan view showing a state in which the optical fiber cord having plural optical fiber elements subjected to the pre-processing step is inserted and fixed in the case;

FIG. 10 is a perspective view showing the optical fiber element arranging portion of the optical fiber element branching member shown in FIG. 6;

FIG. 11 is an explanatory diagram showing an example of arrangement of the optical fiber elements in the optical fiber element arranging portion;

FIG. 12 is a perspective view showing other example of the optical fiber element arranging portion;

FIG. 13 is an explanatory diagram showing an example of the conventional optical fiber element branching member;

FIGS. 14A, 14B are explanatory diagrams showing a processing method for a tension member in the optical fiber element branching member shown in FIG. 13;

FIG. 15 is a perspective view showing the optical fiber element arranging portion of the optical fiber element branching member shown in FIG. 13; and

FIG. 16 is an explanatory diagram showing other example of the processing method for the tension member in the optical fiber element branching member.

### DESCRIPTION OF THE PREFERRED EMBODIMENTS

(First Embodiment)

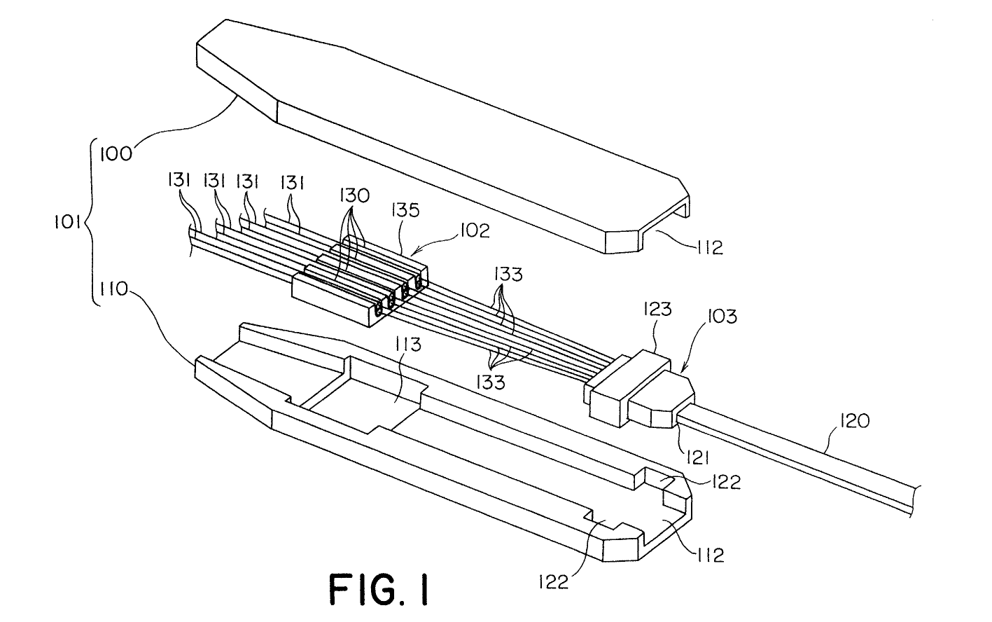

An embodiment of the optical fiber element branching member and the optical fiber element branching method of the present invention will be described with reference to FIGS. 1 to 3. The optical fiber element branching member of this embodiment is capable of branching and taking out respective optical fiber elements from an optical fiber cord having plural optical fiber elements. As shown FIG. 1, optical fiber cord having plural optical fiber elements 120 comprises fiber ribbons (not shown). Each said fiber ribbon has two optical fiber elements. This optical fiber element branching member comprises a base 101, an optical fiber element arranging portion 102 and a cord fixing portion 103 as shown in FIG. 1. The base 101, the optical fiber element arranging portion 102 and the cord fixing portion 103 are separate components.

The aforementioned base 101 comprises a lower material 110 and an upper material 100 which coats thereon as shown in FIG. 1. A concave portion 112 for the fastening portion, which the cord fixing portion 103 can be fit to and a concave portion 113 for the optical fiber element arranging portion, which the optical fiber element arranging portion 102 can be fit to, are formed in inside faces of the upper material 100 and the lower material 110 which face each other. When the base 101 is constructed by matching the upper material 100 with the lower material 110, a fastening portion accommodation space capable of accommodating the cord fixing portion 103 and an arranging portion accommodating space capable of accommodating the optical fiber element arranging portion 102 are formed inside so that both the concave portions for the fastening portion oppose each other while the concave portions for the arranging portion also oppose each other.

As shown in FIG. 1, the aforementioned cord fixing portion 103 has a through hole 121 which allows the optical fiber cord having plural optical fiber elements 120 to pass through and a fitting portion 123 provided on the entire outer periphery thereof so that it is protruded. The fitting portion 123 is formed in such a size allowing the portion to be fit to a fitting portion receiving portion 122 in the concave portion 112 for the fastening portion. Thus, if after the optical fiber cord having plural optical fiber elements 120 is passed through and fixed in the through hole 121, the fitting portion 123 is fit to the concave portion 112 for the fastening portion in the lower material 110 and the upper material 100 is placed on the lower material 110, the cord fixing portion 103 is accommodated between the opposing concave portions 112 for the fastening portion. The fitting portion 123 of the cord fixing portion 103 is fit to the fitting portion receiving portion 122 and the optical fiber cord having plural optical fiber elements 120 is fixed in the base 101 so as to prevent the optical fiber cord having plural optical fiber elements 120 from being deviated in the longitudinal direction.

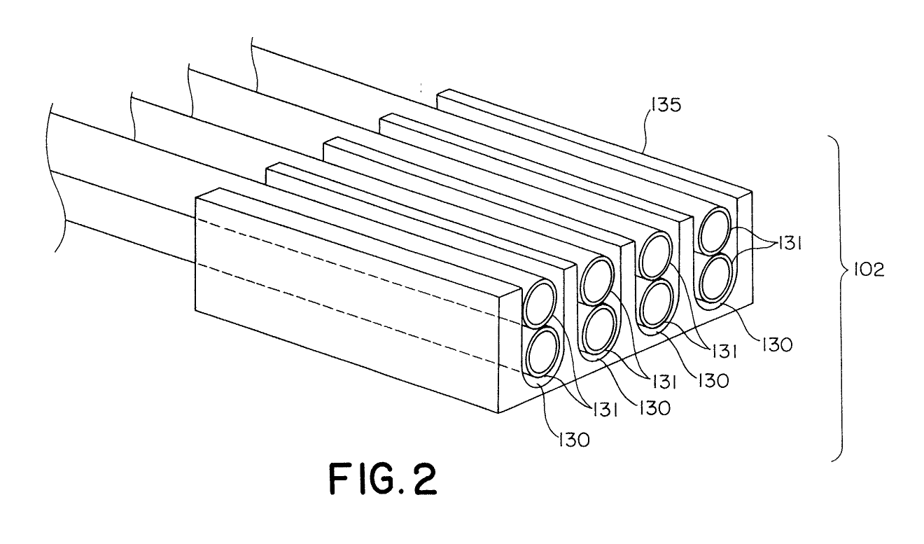

As shown in FIG. 1, the optical fiber element arranging portion 102 includes a tube fastening portion 135 in which four concave grooves 130 are disposed in parallel in the lateral direction thereof and protective tubes 131 are disposed and fixed in those concave grooves 130. Speaking more in detail, as shown in FIG. 2, each of the concave grooves 130 is formed in a substantially U-shape in its cross section so that it is open upward. The width of the section is equal to or slightly larger than the diameter of the protective tube 131. The depth thereof is twice as large as the diameter of the protective tube 131 or slightly larger than that. Meanwhile, it is permissible to form the width slightly smaller than the diameter of the protective tube 131 and press the protective tube 131 into the concave groove 130. The protective tube 131 is a nylon tube of Ø 0.9 mm through which respective optical fiber elements 133 branched from the optical fiber cord having plural optical fiber elements 120 pass. Two protective tubes 131 are placed and fixed in each concave groove 130 so that they are overlaid vertically. If as shown in FIG. 1, the respective optical fiber elements 133 branched from the optical fiber cord having plural optical fiber elements 120 fixed in the cord fixing portion 103 are passed through predetermined protective tubes 131, the optical fiber elements 133 are arranged in the arrangement of the protective tubes 131.

To branch and take out respective optical fiber elements from the optical fiber cord having plural optical fiber elements with the optical fiber element branching member of the present invention having such a structure, the following procedures are taken.

(1) The optical fiber cord having plural optical fiber elements 120 is passed through the through hole 121 in the cord fixing portion 103 and fixed therein and then, respective optical fiber elements 133 are separated from the optical fiber cord having plural optical fiber elements protruded from the through hole 121.

(2) Two protective tubes 131 are disposed in each concave groove 130 in the tube fastening portion 135 so that they are overlaid vertically and then, they are bonded together with adhesive agent in the concave groove 130 so as to produce the optical fiber element arranging portion 102 shown in FIG. 2. In this case, an inlet of each protective tube 131 is preferred to coincide with a beginning end of the concave groove 130 in which the protective tube 131 is accommodated. Thus, the protective tubes 131 are accommodated in the concave grooves 130 so that the inlet of each protective tube 131 coincides with the beginning end of the concave groove 130. Alternatively, after accommodating the protective tubes 131 in the concave grooves 130 so that they are protruded from the beginning ends of the concave grooves 130, excessive portions of the protective tubes 131 protruded from the concave grooves 130 are cut out. In any way, the protective tubes 131 are arranged and fixed in the concave grooves 130. Thus, even an unskilled person can always dispose the protective tubes 131 in the same condition. It is permissible to execute the aforementioned step (1) after this step is finished.

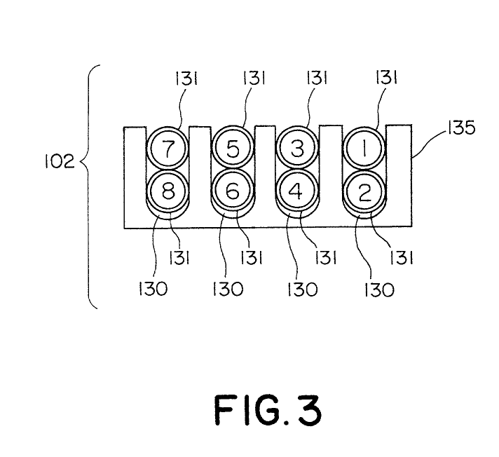

(3) The respective optical fiber elements 133 branched in the manner described in (1) are passed through the protective tubes 131 in the optical fiber element arranging portion 102 so as to ensure the condition shown in FIG. 1. In this case, if numbers of the optical fiber elements 133 to be passed through the protective tubes 131 are determined systematically, it is possible to grasp the number of the respective optical fiber element 133 inserted through the tube 131 by referring to the protective tube 131 through which the optical fiber element 133 is inserted without recognizing each number of the optical fiber element 133. For example, as shown in FIG. 3, a No. 1 optical fiber element 133 is passed through the protective tube 131 upper on the right end column and a No. 2 element 133 is passed through the protective tube 131 lower on the same column. Subsequently, the elements are inserted in order while a No. 8 optical fiber element is passed through the protective tube 131 lower on the left end column.

(4) As shown in FIG. 1, the cord fixing portion 103 and the optical fiber element arranging portion 102 are fit to the concave portion 112 for the fastening portion and the concave portion 113 for the arranging portion. Here, positions of the cord fixing portion 103 and the optical fiber element arranging portion 102 are adjusted so that an unreasonable force is not applied upon the optical fiber elements 133 and after that, by dropping adhesive agent on several positions in the axial direction of the optical fiber element 133, the optical fiber elements are fixed to the lower material 110.

(5) The upper material 100 is placed on the lower material 110 to shield.

(Second Embodiment)

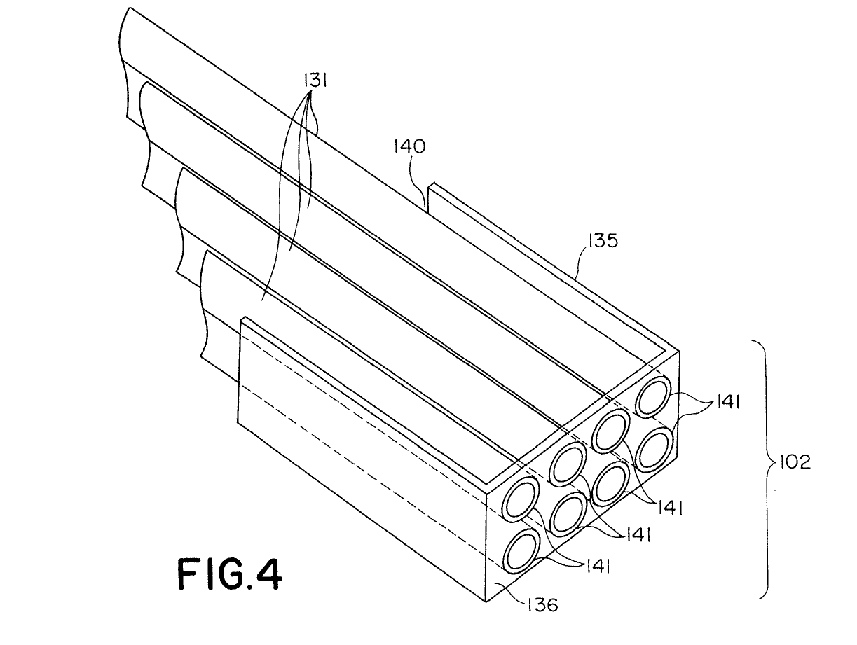

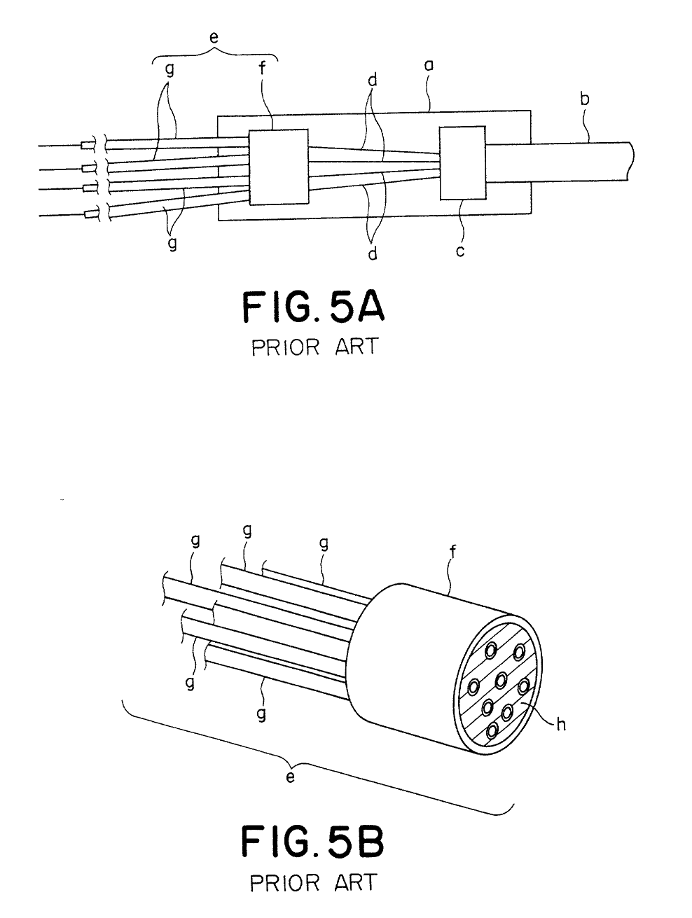

Other embodiment of the optical fiber element branching member of the present invention will be described with reference to FIG. 4. The basic structure of the optical fiber element branching member of this embodiment is the same as that shown in the first embodiment except the structure of the optical fiber element arranging portion.

In the optical fiber element arranging portion 102, an opening portion 140 in which the protective tubes 131 can be inserted is formed in one side of the tube fastening portion 135, whose plan shape is substantially U-like, in the longitudinal direction thereof. Through holes 141 through which the protective tubes 131 can be passed are formed in a front plate 136.

Like the optical fiber element arranging portion of the first embodiment, the optical fiber element arranging portion 102 having the above-described structure is sandwiched between the lower material 110 and the base 101. The method for branching respective optical fiber elements from the optical fiber cord having plural optical fiber elements with the optical fiber element branching member provided with the optical fiber element arranging portion 102 is basically the same as the method described in the first embodiment. What is different from the first embodiment is that ends of the protective tubes 131 are passed through the through holes 141 in the tube fastening portion 135 and fixed thereon so as to produce the optical fiber element arranging portion 102.

(Third Embodiment)

According to the present invention, it is permissible to omit the protective tubes and instead place the optical fiber elements directly in the concave grooves or through holes in the optical fiber element arranging portion so as to arrange the same optical fiber elements. In this case, the positions of the respective optical fiber elements are determined by the concave grooves or through holes and therefore, even an unskilled person can always arrange the optical fiber elements in the same condition. In this case, by discerning the numbers of the optical fiber elements to be passed through the respective concave grooves or through holes systematically, it is possible to grasp the number of the optical fiber element easily in following procedures.

The optical fiber cord having plural optical fiber elements which can be branched with the optical fiber element branching member and optical fiber element branching method of the present invention is not restricted to the 8-element fiber cord. For example, it is possible to branch respective optical fiber elements from such an optical fiber cord having plural optical fiber elements as the 6-element fiber cord and 12 element fiber cord and take them out. Needless to say, depending on the number of the elements in the optical fiber cord having plural optical fiber elements, the numbers of the concave grooves or through holes may be increased or correspondingly, the size, shape and the like of other necessary location may be changed.

(Fourth Embodiment)

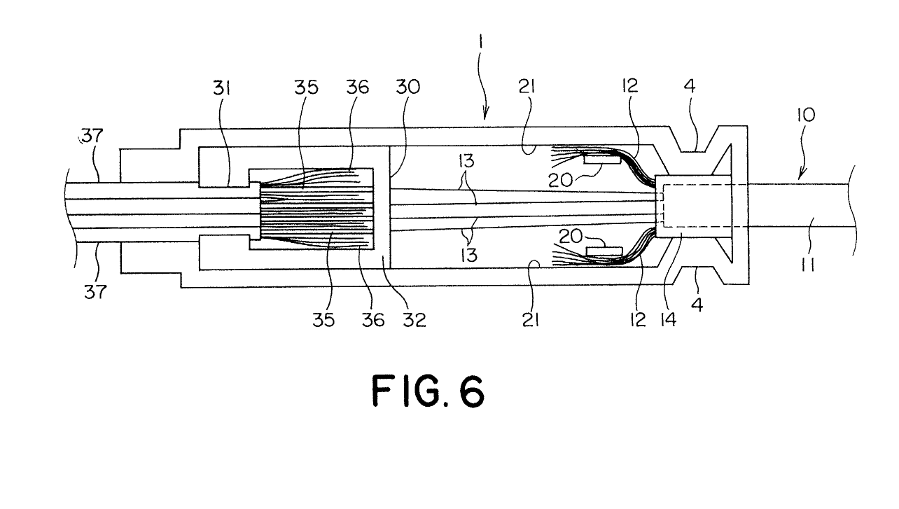

An example of the fourth embodiment of the optical fiber element branching member of the present invention will be described with reference to FIGS. 6 to 11. As shown in FIG. 6, this optical fiber element branching member contains an optical fiber element arranging portion 30 and a holding portion 20 in the case 1. The case 1 allows the optical fiber cord having plural optical fiber elements 10, having eight elements in which a tension member 12 is disposed around the same optical fiber elements and an outside thereof is coated with outside coating 11 to be passed through. The optical fiber element arranging portion 30 is capable of arranging the branched optical fiber elements in a predetermined condition by peeling the outside coating 11 so as to separate and expose the tension member 12. The holding portion 20 holds the tension member 12 peeled from the optical fiber elements 13.

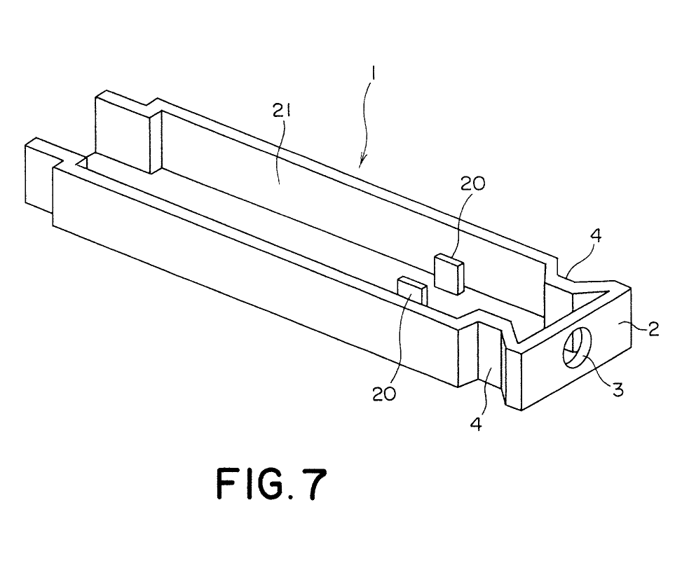

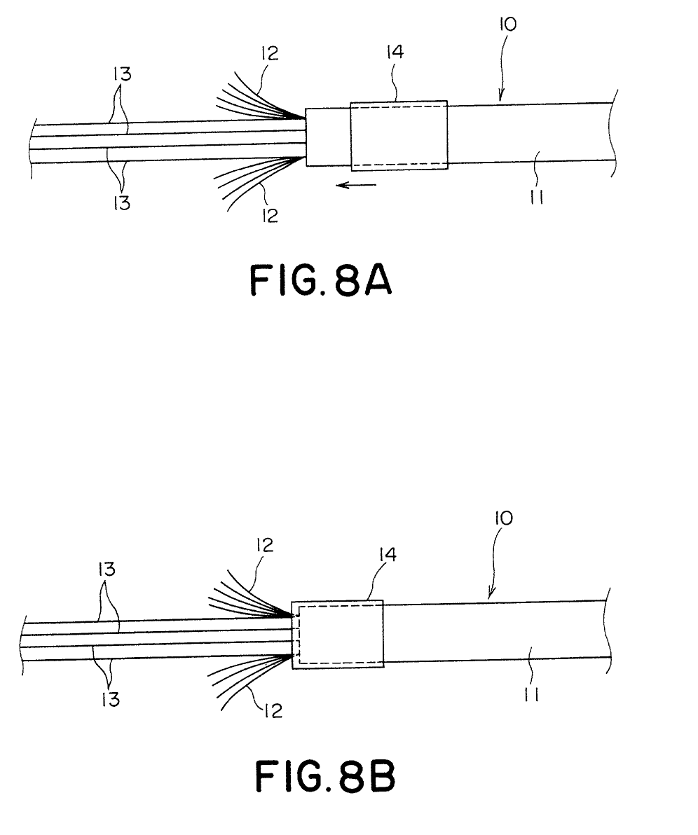

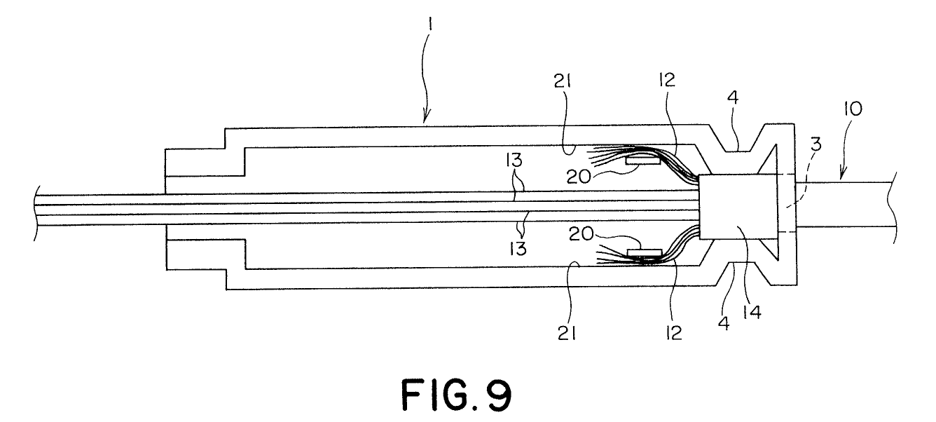

As shown in FIG. 7, the case 1 is formed in the shape of an elongated box whose top is open. An insertion hole 3 is provided in a side face in the longitudinal direction and side faces in the lateral direction are squeezed inward ahead of the insertion hole 3 so that positioning portions 4 are provided so that they oppose each other. As shown in FIG. 6, the positioning portion 4 sandwiches the optical fiber cord having plural optical fiber elements 10 inserted through the insertion hole 3 from both outer sides thereof so as to carry out positioning. If the optical fiber cord having plural optical fiber elements 10 is inserted from the insertion hole 3, the procedure shown in FIG. 8 is taken. That is, after removing the outside coating 11 of the optical fiber cord having plural optical fiber elements 10 in a predetermined length, the tension member is peeled so as to expose the inner optical fiber elements 13 and then the tension member 12 is cut out with a predetermined length thereof left (for example 17 mm). Next, as shown in FIG. 8B, a heat shrinkable tubing 14 mounted on the optical fiber cord having plural optical fiber elements 10 preliminarily is pulled toward the side of the exposed optical fiber elements 13 to coat a root of the tension member 12 with an end portion of the heat shrinkable tubing 14 in a predetermined length (for example, 1 mm). After that, the same heat shrinkable tubing 14 is heated so that it is shrunk. After that, as shown in FIG. 9, the optical fiber cord having plural optical fiber elements 10 is passed through the case 1 through the insertion hole 3 until the heat shrinkable tubing 14 is accommodated in the case 1 and the heat shrinkable tubing 14 accommodated in the case 1 is temporarily fixed in the case 1 with adhesive agent. At this time, as shown in FIG. 6, the heat shrinkable tubing 14 is sandwiched from both sides by the positioning portion 4, so that the optical fiber cord having plural optical fiber elements 10 is positioned.

As shown in FIG. 7, a pair of the sheet-like holding portions 20 are provided protrudedly ahead of the positioning portion 4 in the case 1. More specifically, as shown in FIG. 9, the pair of the holding portions 20 are provided so that they oppose each other with a gap allowing the optical fiber cord having plural optical fiber elements 13 inserted through the insertion hole 3 to pass through. The holding portion 20 is capable of holding the tension member 12 peeled to expose the optical fiber elements 13 between the holding portion and an inner face of the case 1 in the lateral direction. In order to hold the tension member 12 by the holding portions 20, the tension member 12 is divided to equal two sections as shown in FIG. 9 and then, those sections are coated with alcohol or the like so that each of them is integrated and pressed into gaps between the holding portion and the inner face of the case 1 in the lateral direction. At this time, the tension member 12 pressed into the gap depending on the necessity is fastened temporarily with adhesive agent.

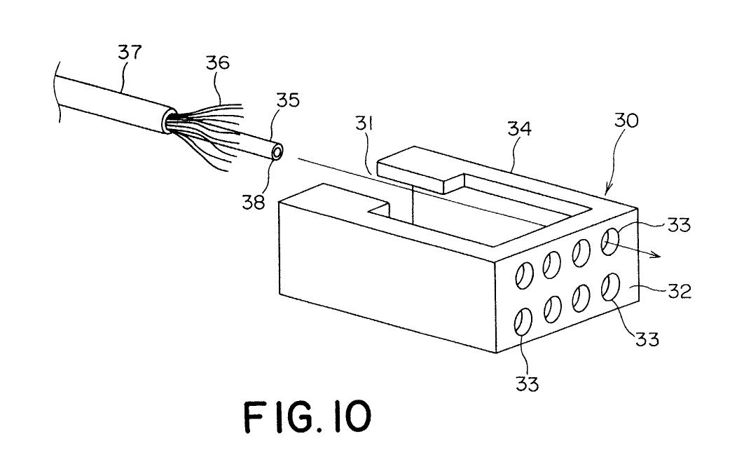

In the optical fiber element arranging portion 30 shown in FIG. 6, an opening portion 31 is formed in a longitudinal direction as shown in FIG. 10 and comprises a tube holding portion 34 whose front panel 32 includes through holes 33 provided vertically and horizontally and protective tubes 35 inserted and fixed in the through holes 33. The protective tube 35 has tension member 36 disposed around the element fiber and its outside thereof is coated with outside coating. When inserting and fixing this protective tube into the through hole 33, the outer coating 37 is removed and the tension member 36 is peeled so as to expose the protective tube 35 and then, the protective tube 33 is inserted and fixed in the through hole 33.

An end portion 38 of the protective tube 35 passed through the through hole 33 is desired to be flush with the front panel 32 of the tube holding portion 34. For the reason, when inserting the protective tube 35 into the through hole 33, the end portion 38 of the protective tube 35 is set up to be flush with the front panel 32 or an excessive portion of the protective tube 35 protruded from the front panel 32 is cut out after. In any way, the location of the protective tube 35 is fixed by the through hole 33 and therefore, even an unskilled person can always dispose the protective tube 35 in the same condition. Therefore, the respective optical fiber elements 13 shown in FIG. 9 are inserted through predetermined protective tubes 35 in the optical fiber element arranging portion 30 and after that, that optical fiber element arranging portion 30 is accommodated at a predetermined position in the case 1 as shown in FIG. 6. Consequently, the respective optical fiber elements 13 of the optical fiber cord having plural optical fiber elements 10 can be always arranged in a specific condition. After the condition shown in FIG. 6 is ensured, the heat shrinkable tubing 14 temporarily fixed and the tension member 12 are fixed finally and then, a lid (not shown) is placed on the case 1 so that it is closed. Consequently, the optical fiber element branching member of the present invention is completed.

If the numbers of the optical fiber elements 13 are determined preliminarily and systematically for respective protective tubes 35 in the optical fiber element arranging portion 30, it is possible to grasp the number of any optical fiber element 13 according to the protective tube 35 through which the appropriate optical fiber element 13 is inserted, without recognizing the number of the optical fiber element 13. For example, as shown in FIG. 11, a No. 1 optical fiber element is passed through the protective tube 35 located on an upper side of the rightmost column as viewed from the front panel 32 including the through holes 33 of the tube holding portion 34, and a No. 2 element is inserted through the protective tube 35 located on a lower side of the same column. Subsequently, the elements are passed through the remaining protective tubes while a No. 8 optical fiber element is passed through the protective tube located on a lower side of the leftmost column.

(Fifth Embodiment)

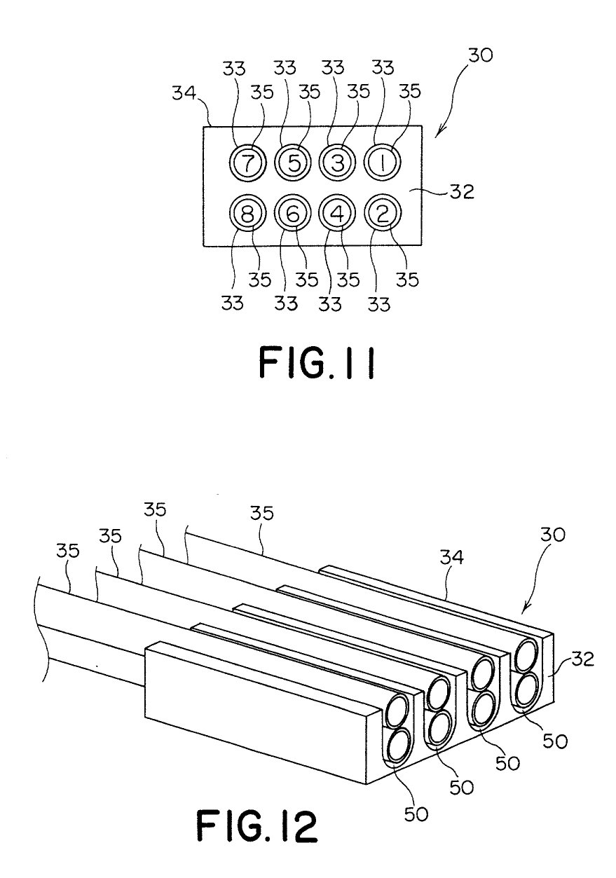

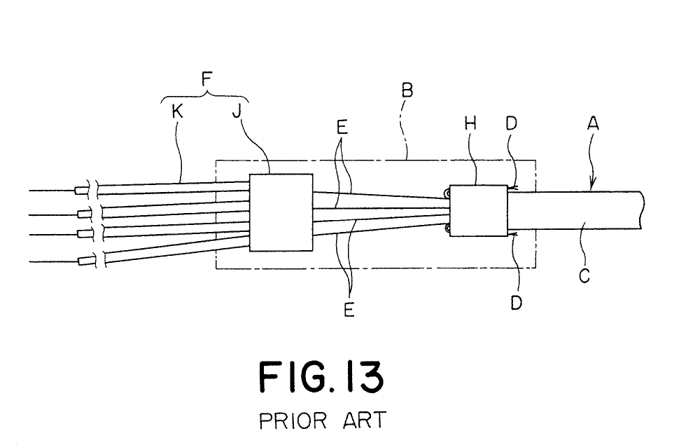

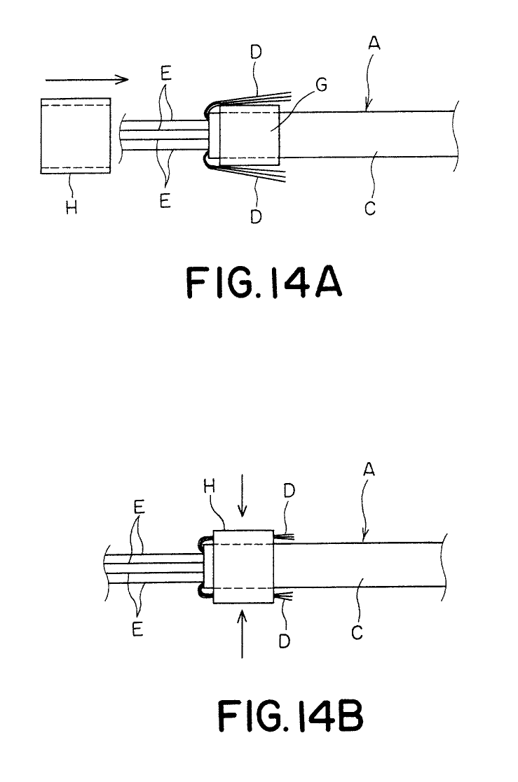

In the optical fiber element arranging portion 30, as shown in FIG. 12, the protective tubes 35 are arranged and fixed in plural concave grooves 50 formed in the tube holding portion 34. Then, the respective optical fiber elements 13 are passed through the protective tubes 35 as shown in FIG. 9 to achieve branching and arrangement of the optical fiber elements. As shown in FIG. 10, the protective tube 35 may be so constructed that the tension member 36 is disposed on the outer periphery and the outside thereof is coated with the outer coating 37. In this case, it is desirable to dispose and fix the optical fiber elements in the concave grooves 50 as they are without peeling the tension member 36 or removing the outer coating 37.

According to the present invention, it is permissible to omit the protective tube 35 in the optical fiber element arranging portion 30 and place the optical fiber elements 13 directly through the through holes 33 (FIG. 10) or in the concave grooves 50 (FIG. 12) so that the optical fiber elements 13 are branched and arranged. In this case, the positions of the optical fiber elements 13 are fixed by the through holes 33 or the concave grooves 50 and therefore, even an unskilled person can always branch and arrange the optical fiber elements 13 in the same condition. Further, by discerning the numbers of the optical fiber elements systematically and preliminarily for every through hole 33 or every concave groove 50, it is possible to grasp the number of any optical fiber element 13 easily after.

The optical fiber cord having plural optical fiber elements, which can be branched with the optical fiber element branching member of the present invention, is not restricted to the 8-element fiber cord. For example, it is possible to branch respective optical fiber elements from such an optical fiber cord having plural optical fiber elements as the 6-element fiber cord and 12-element fiber cord and take them out. Needless to say, depending on the number of the elements in the optical fiber cord having plural optical fiber elements, the numbers of the concave grooves or through holes may be increased or correspondingly, the size, shape and the like of other necessary location may be changed.

### EFFECT OF THE INVENTION

In the optical fiber element branching member according to an aspect of the present invention, the optical fiber element arranging portion includes a plurality of the through holes which allow the optical fiber elements to pass through and by placing individual optical fiber elements branched from the optical fiber cord having plural optical fiber elements through predetermined through holes, the optical fiber elements can be arranged in a desired condition. Therefore, the following effects are found.

(1) Only by inserting predetermined optical fiber elements into predetermined through holes, plural optical fiber elements can be always arranged in the same condition. Thus, even an unskilled person can arrange the optical fiber elements easily and securely in a predetermined condition and further, disparity thereof depending on a worker is eliminated.

(2) If the number of each optical fiber element to be passed through each through hole is preliminarily determined, it is possible to recognize the number of an optical fiber element without confirming the number of each optical fiber element individually.

(3) Because the optical fiber elements are always arranged uniformly, even if an external force is applied to the branching member or the optical fiber cord having plural optical fiber elements connected thereto due to some reason, no serious difference occurs in bending force applied to the respective optical fiber elements. Therefore, no overlapping, twisting or the like occurs between the optical fiber elements and there is no fear that increase of loss or disconnection may be generated.

In an optical fiber element branching member according to another aspect of the present invention, the optical fiber element arranging portion includes plural concave grooves capable of accommodating the optical fiber elements in the optical fiber element arranging portion so as to accommodate the optical fiber elements in predetermined concave grooves. Thus, in addition to the above described effects, the following effect is also found.

(1) Because it is easier to accommodate the optical fiber elements in the concave grooves by dropping from above than to insert the optical fiber elements into the through holes, work efficiency is improved and working time is reduced.

In an optical fiber element branching member according to still another aspect of the present invention, the protective tubes are disposed in the through holes or concave grooves in the optical fiber element arranging portion, so that by placing the optical fiber elements in predetermined through holes or the protective tubes disposed in the concave grooves, the optical fiber elements can be arranged in a desired condition. Therefore, in addition to the above described effects, the following effect is also found.

(1) Because the optical fiber elements are protected by the protective tubes, they are unlikely to be damaged or broken.

In an optical fiber element branching member according to a further aspect of the present invention, both or any one of the cord fixing portion and the optical fiber element arranging portion is/are attachable/detachable to/from the base. Thus, in addition to the above-described effects, the following effect can be recognized.

(1) After the optical fiber cord having plural optical fiber elements is fixed on the cord fixing portion and the respective elements branched from the optical fiber cord having plural optical fiber elements are arranged by the optical fiber element arranging portion, the cord fixing portion and the optical fiber element arranging portion can be mounted on the base. Therefore, as compared to the case where the aforementioned work is carried out with the cord fixing portion and the optical fiber element arranging portion being fixed on the base, the work procedure is facilitated and working time is reduced.

In an optical fiber element branching member according to a still further aspect of the present invention, the case contains the holding portion capable of holding the tension member peeled from the optical fiber elements. Thus, the following effect is also recognized.

(1) A separate part shown in FIG. 9 is not necessary for holding the tension member of the optical fiber cord having plural optical fiber elements peeled to expose the optical fiber elements and consequently, production cost is reduced correspondingly.

In an optical fiber element branching member according to a still further aspect of the present invention, the holding can be fixed on the case so that it does not contact the optical fiber element whose tension member is exposed. Thus, in addition to the above-described effects, the following effects are found.

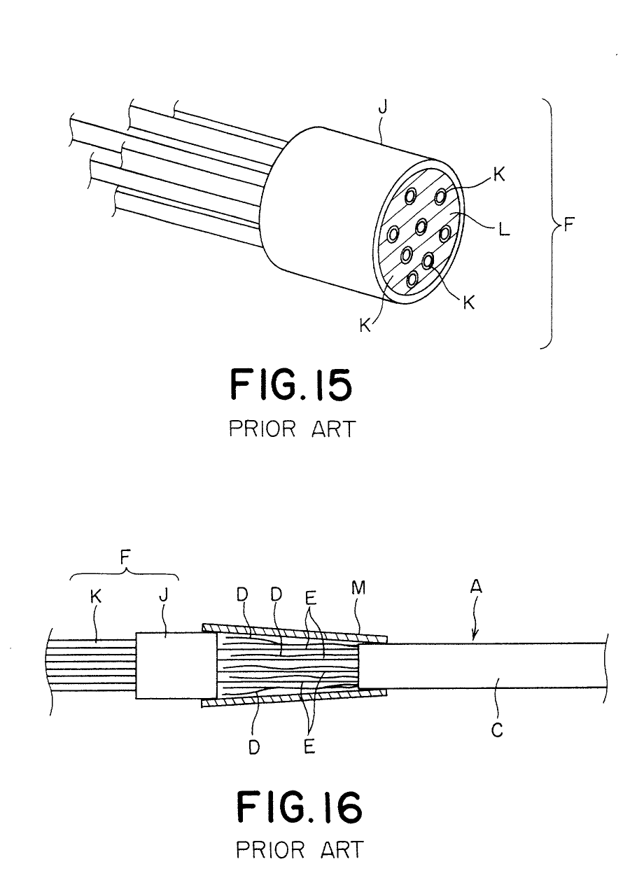

(1) There is no fear that the tension member may contact the optical fiber element thereby deteriorating transmission loss unlike a case (FIG. 16) of treating the tension member and the optical fiber elements together using the heat shrinkable tubing.

(2) Because the optical fiber element is not coated with the aforementioned heat shrinkable tubing or the tension member, even if bending or twisting occurs in the same element, these can be grasped immediately so that the yield rate is improved as compared to the conventional case.

In an optical fiber element branching member according to a still further aspect of the present invention, the optical fiber element arranging portion includes plural through holes or concave grooves allowing the optical fiber elements to pass through and by only inserting the branched optical fiber elements into predetermined through holes or accommodating them in the concave grooves, those optical fiber elements can be arranged in a predetermined condition. Thus, in addition to the above-described effects, the following effects are also secured.

(1) Even an unskilled worker can always arrange plural optical fiber elements in a predetermined condition and therefore, there is no disparity depending on the worker.

(2) If the number of each optical fiber element to be inserted in each through hole or accommodated in each concave groove is preliminarily determined, it is possible to recognize the number of the optical fiber element without confirming the number of each optical fiber element individually.

(3) Because the optical fiber elements are always arranged uniformly, even if an external force is applied to the branching portion or the optical fiber cord having plural optical fiber elements connected thereto due to some reason, no serious difference occurs in the bending forces applied to the respective optical fiber elements. Thus, no overlapping, twisting and the like occur between the optical fiber elements and there is no fear that increase of loss or disconnection is generated.

In an optical fiber element arranging member according to a still further aspect of the present invention, the protective tubes are disposed in the through holes or concave grooves in the optical fiber element arranging portion and by inserting the branched optical fiber elements into the protective tubes disposed in predetermined through holes or accommodating in predetermined concave grooves, the optical fiber elements can be arranged in a predetermined condition. Thus, in addition to the above-described effects, the following effect is also secured.

(1) Because the optical fiber element is protected by the protective tube, it is unlikely to be damaged or broken, so that a highly reliable branching member is produced.

In an optical fiber element branching member according to a still further aspect of the present invention, because the tension member is disposed on the periphery of the protective tube and further outside thereof is coated with outer coating, the following effect is also secured.

(1) The optical fiber element is protected further strongly, so that the reliability as the branching member is intensified.

In an optical fiber element branching member according to a still further aspect of the present invention, because the care arranging portion is/are attachable/detachable to/from the case, the following effect is also secured.

(1) After arranging the exposed respective optical fiber elements in the optical fiber element arranging portion, that optical fiber element arranging portion can be accommodated in the case. Therefore, as compared to the case where the aforementioned work is carried out with the optical fiber element arranging portion being accommodated in the case, work efficiency is better and the assembly time is reduced.

According to the optical fiber element branching method of the present invention, because the respective optical fiber elements are branched from the optical fiber cord having plural optical fiber elements and taken out of it using the optical fiber element branching member having the above-described effects, the branching work is facilitated and even an unskilled worker can execute the work easily and securely. Further, disparity depending of work efficiency depending on worker is eliminated and working time is reduced.

What is claimed is:

1. An optical fiber element branching member comprising: a cord fixing portion through which an optical fiber cord having plural optical fiber elements is to be inserted; an optical fiber element arranging portion for arranging optical fiber elements branched from the optical fiber cord having plural optical fiber elements passed through the cord fixing portion individually; and a base in which the cord fixing portion and the optical fiber element arranging portion are set up, wherein said optical fiber element arranging portion includes two or more through holes allowing the optical fiber elements to pass through and if the optical fiber elements are inserted through predetermined through holes individually, the optical fiber elements are arranged in a desired condition.

2. An optical fiber element branching member comprising: a cord fixing portion through which an optical fiber cord having plural optical fiber elements is to be inserted; an optical fiber element arranging portion for arranging optical fiber elements branched from the optical fiber cord having plural optical fiber elements passed through the cord fixing portion individually; and a base in which the cord fixing portion and the optical fiber element arranging portion are set up, wherein said optical fiber element arranging portion includes two or more concave grooves allowing the optical fiber elements to accomodate and if the optical fiber elements are accommodated in predetermined concave grooves individually, the optical fiber elements are arranged in a desired condition.

3. An optical fiber element branching member comprising: a cord fixing portion through which an optical fiber cord having plural optical fiber elements is to be inserted; an optical fiber element arranging portion for arranging optical fiber elements branched from the optical fiber cord having plural optical fiber elements passed through the cord fixing portion individually; and a base in which the cord fixing portion and the optical fiber element arranging portion are set up, wherein said optical fiber element arranging portion includes two or more through holes allowing the optical fiber elements to pass through, while the protective tubes are disposed in the respective through holes in the optical fiber element arranging portion and if the optical fiber elements branched from an optical fiber cord having plural optical fiber elements fixed in the cord fixing portion are passed through predetermined protective tubes individually, the optical fiber elements are arranged in a desired condition.

4. An optical fiber element branching member comprising: a cord fixing portion through which an optical fiber cord having plural optical fiber elements is to be inserted; an optical fiber element arranging portion for arranging optical fiber elements branched from the optical fiber cord having plural optical fiber elements passed through the cord fixing portion individually; and a base in which the cord fixing portion and the optical fiber element arranging portion are set up, wherein said optical fiber element arranging portion includes two or more concave grooves allowing the optical fiber elements to pass through, so that the protective tubes are disposed in respective concave grooves in the optical fiber element arranging portion and if optical fiber elements branched from an optical fiber cord having plural optical fiber elements fixed in the cord fixing portion are inserted through predetermined protective tubes individually, the optical fiber elements are arranged in a desired condition.

5. An optical fiber element branching member comprising: a cord fixing portion through which an optical fiber cord having plural optical fiber elements is to be inserted; an optical fiber element arranging portion for arranging optical fiber elements branched from the optical fiber cord having plural optical fiber elements passed through the cord fixing portion individually; and a base in which the cord fixing portion and the optical fiber element arranging portion are set up, wherein said optical fiber element arranging portion includes two or more through holes allowing the optical fiber elements to pass through and if the optical fiber elements are inserted through predetermined through holes individually, the optical fiber elements are arranged in a desired condition and both or any one of said cord fixing portion and said optical fiber element arranging portion is/are attachable/detachable to/from the base.

6. An optical fiber element branching member comprising: a cord fixing portion through which an optical fiber cord having plural optical fiber elements is to be inserted; an optical fiber element arranging portion for arranging optical fiber elements branched from the optical fiber cord having plural optical fiber elements passed through the cord fixing portion individually; and a base in which the cord fixing portion and the optical fiber element arranging portion are set up, wherein both or any one of the cord fixing portion and the optical fiber element arranging portion is/are attachable/detachable to/from the base and said optical fiber element arranging portion includes two or more concave grooves allowing the optical fiber elements to accomodate and if the optical fiber elements are accommodated in predetermined concave grooves individually, the optical fiber elements are arranged in a desired condition.

7. An optical fiber element branching member comprising: a cord fixing portion through which an optical fiber cord having plural optical fiber elements is to be inserted; an optical fiber element arranging portion for arranging optical fiber elements branched from the optical fiber cord having plural optical fiber elements passed through the cord fixing portion individually; and a base in which the cord fixing portion and the optical fiber element arranging portion are set up, wherein both or any one of the cord fixing portion and the optical fiber element arranging portion is/are attachable/detachable to/from the base and said optical fiber element arranging portion includes two or more through holes allowing the optical fiber elements to pass through, while the protective tubes are disposed in the respective through holes in the optical fiber element arranging portion and if the optical fiber elements branched from an optical fiber cord having plural optical fiber elements fixed in the cord fixing portion are passed through predetermined protective tubes individually, the optical fiber elements are arranged in a desired condition.

8. An optical fiber element branching member comprising: a cord fixing portion through which an optical fiber cord having plural optical fiber elements is to be inserted; an optical fiber element arranging portion for arranging optical fiber elements branched from the optical fiber cord having plural optical fiber elements passed through the cord fixing portion individually; and a base in which the cord fixing portion and the optical fiber element arranging portion are set up, wherein said optical fiber element arranging portion includes two or more concave grooves allowing the optical fiber elements to accommodate, so that the protective tubes are disposed in respective concave grooves in the optical fiber element arranging portion and if optical fiber elements branched from an optical fiber cord having plural optical fiber elements fixed in the cord fixing portion are inserted through the protective tubes individually, the optical fiber elements are capable of being arranged in a desired condition.

9. An optical fiber element branching member wherein an optical fiber element arranging portion and a holding portion are provided in a case allowing an optical fiber cord having plural optical fiber elements in which a tension member is disposed around plural optical fiber elements and outside thereof is coated with an outer coating to pass through, said optical fiber element arranging portion being capable of arranging optical fiber elements of the optical fiber cord having plural optical fiber elements passed through the case, said holding portion being capable of holding the tension member peeled from the optical fiber element.

10. An optical fiber element branching member wherein an optical fiber element arranging portion and a holding portion are provided in a case allowing an optical fiber cord having plural optical fiber elements in which a tension member is disposed around plural optical fiber elements and outside thereof is coated with an outer coating to pass through, said optical fiber element arranging portion being capable of arranging optical fiber elements of the optical fiber cord having plural optical fiber elements passed through the case, said holding portion being capable of holding the tension member such that the tension member peeled from the optical fiber element does not contact the optical fiber element.

11. An optical fiber element branching member wherein an optical fiber element arranging portion and a holding portion are provided in a case allowing an optical fiber cord having plural optical fiber elements in which a tension member is disposed around plural optical fiber elements and outside thereof is coated with an outer coating to pass through, said optical fiber element arranging portion being capable of arranging optical fiber elements of the optical fiber cord having plural optical fiber elements passed through the case, said holding being capable of holding the tension member so that the tension member peeled from the optical fiber element does not contact the optical fiber element, said optical fiber element arranging portion including two or more through holes allowing two or more branched optical fiber elements to pass through individually so that if the optical fiber elements branched from an optical fiber cord having plural optical fiber elements are inserted through predetermined through holes individually, the optical fiber elements are capable of being arranged in a predetermined condition.

12. An optical fiber element branching member wherein an optical fiber element arranging portion and a holding portion are provided in a case allowing an optical fiber cord having plural optical fiber elements in which a tension member is disposed around plural optical fiber elements and outside thereof is coated with an outer coating to pass through, said optical fiber element arranging portion being capable of arranging optical fiber elements of the optical fiber cord having plural optical fiber elements passed through the case, said holding being capable of holding the tension member so that the tension member peeled from the optical fiber element does not contact the optical fiber element, said optical fiber element arranging portion including two or more through holes allowing two or more branched optical fiber elements to pass through individually so that if the optical fiber elements branched from an optical fiber cord having plural optical fiber elements are inserted through predetermined through holes individually, the optical fiber elements are arranged in a predetermined condition.

13. An optical fiber element branching member wherein an optical fiber element arranging portion and a holding portion are provided in a case allowing an optical fiber cord having plural optical fiber elements in which a tension member is disposed around plural optical fiber elements and outside thereof is coated with an outer coating to pass through, said optical fiber element arranging portion being capable of arranging optical fiber elements of the optical fiber cord having plural optical fiber elements passed through the case, said holding portion being capable of holding a tension member peeled from the optical fiber element, said optical fiber element arranging portion including two or more concave grooves capable of accommodating two or more branched optical fiber elements individually, so that if the optical fiber elements branched from the optical fiber cord having plural optical fiber elements are accommodated in predetermined concave grooves individually, the optical fiber elements are arranged in a predetermined condition.

14. An optical fiber element branching member wherein an optical fiber element arranging portion and a holding portion are provided in a case allowing an optical fiber cord having plural optical fiber elements in which a tension member is disposed around plural optical fiber elements and outside thereof is coated with an outer coating to pass through, said optical fiber element arranging portion being capable of arranging optical fiber elements of the optical fiber cord having plural optical fiber elements passed through the case, said holding portion being capable of holding the tension member peeled from the optical fiber element so that it does not contact the optical fiber element, said optical fiber element arranging portion including two or more concave grooves capable of accommodating two or more branched optical fiber elements individually, so that if the optical fiber elements branched from the optical fiber cord having plural optical fiber elements are accommodated in predetermined concave grooves, the optical fiber elements are capable of being arranged in a predetermined condition.

15. An optical fiber element branching member wherein an optical fiber element arranging portion and a holding portion are provided in a case allowing an optical fiber cord having plural optical fiber elements in which a tension member is disposed around plural optical fiber elements and outside thereof is coated with an outer coating to pass through, said optical fiber element arranging portion being capable of arranging optical fiber elements of the optical fiber cord having plural optical fiber elements passed through the case, said holding portion being capable of holding the tension member peeled from the optical fiber element,. said optical fiber element arranging portion including two or more through holes or concave grooves allowing two or more branched optical fiber elements to accommodate individually, so that if the protective tubes are disposed in the through holes or concave grooves and the optical fiber elements branched from an optical fiber cord having plural optical fiber elements are passed through predetermined protective tubes individually, the optical fiber elements are arranged in a predetermined condition.

16. An optical fiber element branching member wherein an optical fiber element arranging portion and a holding portion are provided in a case allowing an optical fiber cord having plural optical fiber elements in which a tension member is disposed around plural optical fiber elements and outside thereof is coated with an outer coating to pass through, said optical fiber element arranging portion being capable of arranging optical fiber elements of the optical fiber cord having plural optical fiber elements passed through the case, said holding portion being capable of holding the tension member peeled from the optical fiber element so that it does not contact the optical fiber element, said optical fiber element arranging portion including two or more through holes or concave grooves capable of passing through two or more branched optical fiber elements, so that if the protective tubes are disposed in the through holes or concave grooves and the optical fiber elements branched from an optical fiber cord having plural optical fiber elements are passed through predetermined protective tubes individually, the optical fiber elements are arranged in a predetermined condition.

17. An optical fiber element branching member wherein an optical fiber element arranging portion and a holding portion are provided in a case allowing an optical fiber cord having plural optical fiber elements in which a tension member is disposed around plural optical fiber elements and outside thereof is coated with an outer coating to pass through, said optical fiber element arranging portion being capable of arranging optical fiber elements of the optical fiber cord having plural optical fiber elements passed through the case, said holding portion being capable of holding the tension member peeled from the optical fiber element, said optical fiber element arranging portion including two or more through holes or concave grooves allowing two or more optical fiber elements to pass through individually, so that if the protective tubes, whose outer coating is removed and whose tension member are peeled, are disposed in the through holes or concave grooves and the optical fiber elements branched from an optical fiber cord having plural optical fiber elements are passed through predetermined protective tubes individually, the optical fiber elements are arranged in a predetermined condition.

18. An optical fiber element branching member wherein an optical fiber element arranging portion and a holding portion are provided in a case allowing an optical fiber cord having plural optical fiber elements in which a tension member is disposed around plural optical fiber elements and outside thereof is coated with an outer coating to pass through, said optical fiber element arranging portion being capable of arranging optical fiber elements of the optical fiber cord having plural optical fiber elements passed through the case, said holding portion being capable of holding the tension member peeled from the optical fiber element so that it does not contact the optical fiber element, said optical fiber element arranging portion including two or more through holes or concave grooves capable of accommodating two or more branched optical fiber elements, so that if the protective tubes, whose outer coating is removed and whose tension member is peeled, are disposed in the through holes or concave grooves and the optical fiber elements branched from an optical fiber cord having plural optical fiber elements are passed through predetermined protective tubes individually, the optical fiber elements are arranged in a predetermined condition.

19. An optical fiber element branching member as claimed in claim 9 to 18 wherein said optical fiber element arranging portion is/are attachable/detachable to/from the case.

20. An optical fiber element branching method for branching the optical fiber elements from an optical fiber cord having plural optical fiber elements with the optical fiber element branching member according to claim 5 to 8, comprising steps of:
inserting and fixing the multi-element optical fiber element in the cord fixing portion;
arranging two or more optical fiber elements branched from the optical fiber cord having plural optical fiber elements in a desired condition by inserting the optical fiber elements into the through holes in the optical fiber element arranging portion or accommodating in the concave grooves or inserting the optical fiber elements into the protective tubes disposed in the through holes or the concave grooves; and
mounting the cord fixing portion and the optical fiber element arranging portion on the base.
